(19) United States
(12) Patent Application Publication
(10) Pub. No.: US 2024/0394753 A1
(43) Pub. Date: Nov. 28, 2024

(54) System And Method For Restricting Traffic Based On Brands Specified In A Campaign

(71) Applicant: Google LLC, Mountain View, CA (US)

(72) Inventors: Vidya Pramod Kamarajugadda, Bangalore (IN); Durga Deepthi Singh Sharma, Bangalore (IN); Walter Alejandro Vulej, Mountain View, CA (US)

(21) Appl. No.: 18/588,843

(22) Filed: Feb. 27, 2024

(30) Foreign Application Priority Data
May 22, 2023 (IN) 202321035547

(51) Int. Cl. G06Q 30/0241

(52) U.S. Cl. CPC G06Q 30/0276; G06Q 30/0277

(57) ABSTRACT

The technology generally relates to providing sponsored digital content items on a publisher's website or mobile application based on a campaign created by a digital content provider, wherein the campaign specifies specific brands. The specified brands may be used to direct traffic, such that the digital content provider's products or services from the campaign may be included in digital content items when a query matches permitted brands. In other examples, the digital content provider's campaign will not be published in a sponsored digital content item in response to a search query that matches a brand which the campaign specifies as an exclusion.

### BACKGROUND

Sponsored digital content typically appear on a retailer's website or mobile application alongside organic search results when a user performs a search or browses a product category. Creating campaigns for sponsored digital content often requires entering keywords, which are intended to capture all variations of possible searches for the product or service associated with the sponsored digital content. This is cumbersome as digital content providers have to think of all possible variations and search terms in an effort to have their sponsored digital content selected. Moreover, the digital content providers typically have to manually map keywords to a product, which makes it difficult to be comprehensive or accurate when trying to differentiate between products with similar terms, e.g., milk chocolate and chocolate milk.

### BRIEF SUMMARY

The technology generally relates to providing sponsored digital content on a publisher's website or mobile application based on a user's selection of specific brands to include or exclude. The user's query or content filter may be used to automatically identify associated products and services. For example, a digital content server may identify associated products and services using language processing to identify keywords related to the user's query or content filter, wherein the keywords include synonyms, spell-correction, or related terms to those in the user's query. To determine one or more sponsored digital content items to transmit to the publisher, the digital content server may identify available products or services being advertised by the publisher. The digital content server matches the available products or services to the keywords or synonyms identified using the language processing. The digital content server may determine a score, such as a quality score, for each match. The quality score may provide an indication of how similar the available product or service is to the search query or the keywords generated by the digital content server. For example, a high score may indicate that the available product or service is what users associate with the query, content filter, or digital content server generated keyword. The digital content server may rank the identified products and services based on the quality score. The digital content server may solicit bids from digital content providers for the highest ranked products or services. The winning digital content item may be returned to the publisher for output in addition to the search results.

One aspect of the disclosure provides a method, comprising receiving, by one or more processors, campaign information associated with one or more campaigns from digital content providers, wherein the campaign information includes a selection of one or more specified brands; receiving, by the one or more processors from a publisher, a request for a sponsored digital content items for display on a content page of a publisher, the request associated with a search query received by the publisher; determining, by the one or more processors based on the search query and the one or more specified brands, one or more candidate campaigns; selecting, by the one or more processors, a selected campaign of the one or more candidate campaigns; and providing to the publisher a digital content item associated with the selected campaign for publishing in association with a response to the search query. The selected one or more specified brands may include a specified brand inclusion list of included brands for which the campaign should be included as a candidate campaign if the one or more specified brands match the search query. The selection of one or more specified brands may include a specified brand exclusion list of excluded brands for which the campaign should not be included as a candidate campaign if the one or more specified brands match the search query. The selection may be performed through a user interface enabling selection of brands listed in a brand library. The brand library may identify one or more uniform resource locators (URLs) associated with each brand. The brand library may identify a business associated with each brand. The brand library may identify an industry, product, or service associated with each brand.

According to some examples, the method may further include ranking, by the one or more processors based on the determined degree of the match, the one or more candidate campaigns. According to some examples, the method may further include receiving, by the one or more processors from the digital content providers of the identified at least one or more campaigns, bids on the highest ranked one or more available products; and providing, by the one or more processors for output on the content page of the publisher based on a winning bid, the at least one campaign as a digital content item.

Another aspect of the disclosure provides a system, comprising memory and one or more processors, the one or more processors configured to execute operations. Such operations may include receiving campaign information associated with one or more campaigns from digital content providers, wherein the campaign information includes a selection of one or more specified brands; receiving, from a publisher, a request for a sponsored digital content item for display on a content page of a publisher, the request associated with a search query received by the publisher; determining, based on the search query and the one or more specified brands, one or more candidate campaigns; selecting a selected campaign of the one or more candidate campaigns; and providing to the publisher a digital content item associated with the selected campaign for publishing in association with a response to the search query.

The selected one or more specified brands may include a specified brand inclusion list of included brands for which the campaign should be included as a candidate campaign if the one or more specified brands match the search query. The selected one or more specified brands may include a specified brand exclusion list of excluded brands for which the campaign should not be included as a candidate campaign if the one or more specified brands match the search query. The selection of one or more specified brands may include selection through a user interface of brands listed in a brand library. The brand library may identify one or more uniform resource locators (URLs) associated with each brand. The brand library may identify a business associated with each brand. The brand library may identify an industry, product, or service associated with each brand.

In some examples, the one or more processors may be further configured to rank, based on the determined degree of the match, the one or more candidate campaigns. According to some examples, the one or more processors may be further configured to receive, from the digital content providers of the identified at least one or more campaigns, bids on the highest ranked one or more available products; and providing, by the one or more processors for output on the content page of the publisher based on a winning bid, the at least one campaign as a sponsored digital content item.

Yet another aspect of the disclosure provides a non-transitory computer-readable medium storing instructions, which when executed by one or more processors, cause the one or more processors to execute a method comprising receiving campaign information associated with one or more campaigns from digital content providers, wherein the campaign information includes a selection of one or more specified brands; receiving, from a publisher, a request for a sponsored digital content item for display on a content page of a publisher, the request associated with a search query received by the publisher; determining, based on the search query and the one or more specified brands, one or more candidate campaigns; selecting a selected campaign of the one or more candidate campaigns; and providing to the publisher a sponsored digital content item associated with the selected campaign for publishing in association with a response to the search query.

### BRIEF DESCRIPTION OF THE DRAWINGS

FIG. 1 is a pictorial representation of a campaign that directs traffic based on specified brands according to aspects of the disclosure.

FIG. 2 is a pictorial representation of a digital content item generated in response to a query according to aspects of the disclosure.

FIG. 3 is a pictorial representation of a digital content item that would not be served based on brand exclusion according to aspects of the disclosure.

FIG. 4 is an example user interface for creating a campaign according to aspects of the disclosure.

FIG. 5 is an example user interface illustrating adding brands to the campaign according to aspects of the disclosure.

FIG. 6 is an example user interface illustrating a request to create a new brand entry in a brand library according to aspects of the disclosure.

FIG. 7 is an example sequence diagram according to aspects of the disclosure.

FIG. 8A is a screenshot illustrating an example arrangement of content output via a webpage according to aspects of the disclosure.

FIG. 8B is a screenshot illustrating an example arrangement of content output via a mobile application according to aspects of the disclosure.

FIG. 9 is a functional diagram illustrating an example system according to aspects of the disclosure.

FIG. 10 is a flow diagram illustrating an example method of creating a brand list for a campaign according to aspects of the disclosure.

FIG. 11 is a flow diagram illustrating an example method of identifying campaigns specifying a particular brand for inclusion according to aspects of the disclosure.

FIG. 12 is a flow diagram illustrating an example method of excluding campaigns that exclude a particular brand according to aspects of the disclosure.

### DETAILED DESCRIPTION

The technology generally relates to providing sponsored digital content items on a search engine or publisher's website or mobile application based on a campaign created by a digital content provider, wherein the campaign specifies specific brands. The specified brands may be used to direct traffic, such that the digital content provider's products or services from the campaign may be included in digital content items when a query matches permitted brands. In other examples, the digital content provider's campaign will not be published in a sponsored digital content item in response to a search query that matches a brand which the campaign specifies as an exclusion.

The sponsored digital content items may be for products, services, organizations, ideas, messages, etc. being offered by the publisher or retailer. Sponsored digital content items may be an ad on which an advertiser has bid to have displayed on the publisher's website. Sponsored digital content items may enable the digital content provider to target a receptive user by identifying digital content items relevant to a user's query. For example, a digital content provider may create a campaign for one or more products, services, etc., The campaign may be received by a digital content server. The digital content server may receive a request for sponsored digital content items from a publisher. The request may correspond to a search query received by the publisher. The digital content server may use language processing for the terms in the search query to generate one or more keywords related to the search query. For example, the keywords may be generated using synonyms of terms in the search query, spelling correction of terms in the search query, and or machine learning based on historical customer clicks in connection with similar search queries. The digital content server may identify products or services that are available for advertisement on the publisher's website or mobile application. The digital content server may match the available products and services to the search query and/or generated keywords. According to some examples, each match may have a quality score indicating a likelihood that the product or service is what users associate with the search query. The digital content server may rank the available products and services based on their quality score. The digital content server may solicit bids from digital content providers for the highest ranked products and services. At the conclusion of the bidding, the digital content server may return the winning digital content items to the publisher for output.

The digital content provider may be, for example, a manufacturer, retailer, service provider, etc. The digital content provider may create campaigns for products or services on the publisher's website. According to some examples, the campaigns may be for sponsored or featured products on the publisher's website. The publisher may be, for example, a retailer or a search engine. The publisher may maintain a catalog of products or services offered by the publisher. According to some examples, the publisher may identify which products or services are available to be sponsored. For purposes of case and clarity throughout the specification, products, services, messages, ideas, etc. may be collectively referred to as “products.”

The digital content server may select campaigns based on other information in addition to specified brands. For example, the digital content server may select campaigns based on a combination of specified brands and keywords or other information. Because the digital content server selects campaigns based on specified brands in response to a search query, digital content providers may target more relevant audiences and exclude unwanted traffic. For example, if a digital content provider pays per click or per publication, they likely do not want their digital content items to be published if they will be clicked by a user that is confused and/or not actually interested in the digital content provider's product. For example, if a jewelry company and a music streaming service have the same name, the jewelry company will likely want to avoid paying for clicks by users that thought they were reaching the music subscription service as those clicks are unlikely to end in conversions. Moreover, by preventing publishing of digital content items for campaigns where particular excluded brands match the search query, power and network resources are conserved. For example, bandwidth is conserved by preventing transmission of such digital content items, power is conserved by omitting them from display, and bandwidth is further conserved by reducing unintended interaction with such digital content items.

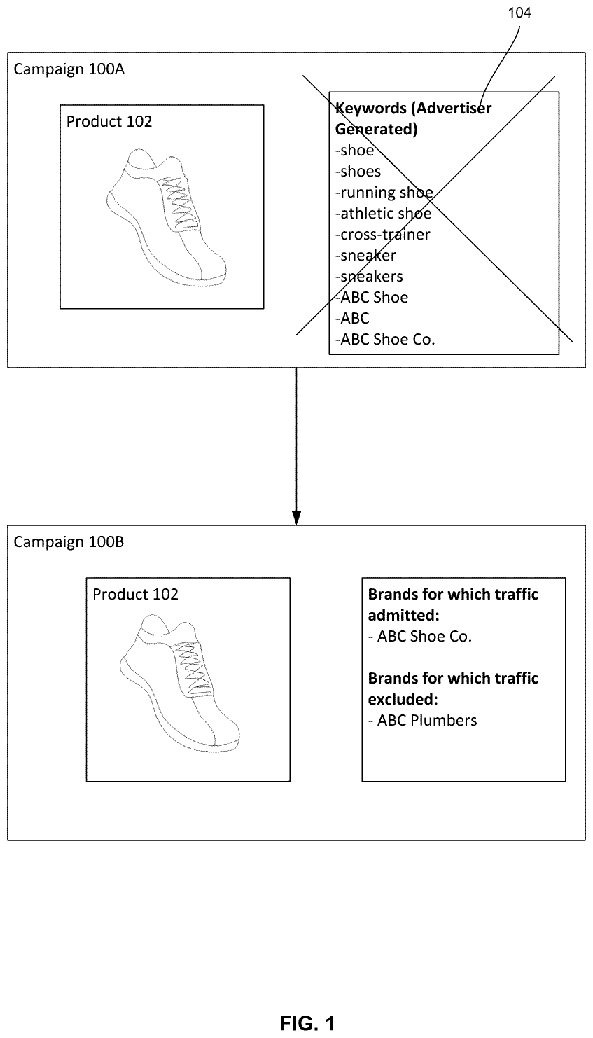

FIG. 1 illustrates a campaign 100B based on specific brands, as compared to a typical campaign 100A based on keywords only. Campaign 100A represents a typical campaign, including an identification of a product 102, shown as a shoe, and a list of digital content provider generated keywords 104. In conventional systems, the digital content provider, looking to promote the shoes in response to a greater number of search queries, would enter keywords including different brands, models, features, colors, types of shoes (e.g., running, athletics, cross-trainers, etc.), variations of the word “shoe” (e.g., shoe, shoes, sneaker, sneakers, etc.), as part of the campaign 100A.

Campaign 100B, as shown, may be generated using specific brands. For example, a first set of specified brands may be listed for inclusion. Additionally, or alternatively, a second set of specified brands may be listed for exclusion. Each listed brand may be matched with a specific URL and/or other information that clarifies to which business the brand belongs. Such other information may include, for example, a listing of relevant industry, products, sub-brands or related brands, images, etc. In this regard, if two businesses have similar names, the correct business may be identified. For example, if both a shoe company and a plumbing business are named ABC, a digital content provider may specify that the digital content could be served in response to queries matching the shoe company ABC but should be excluded for search queries matching the plumbing company ABC.

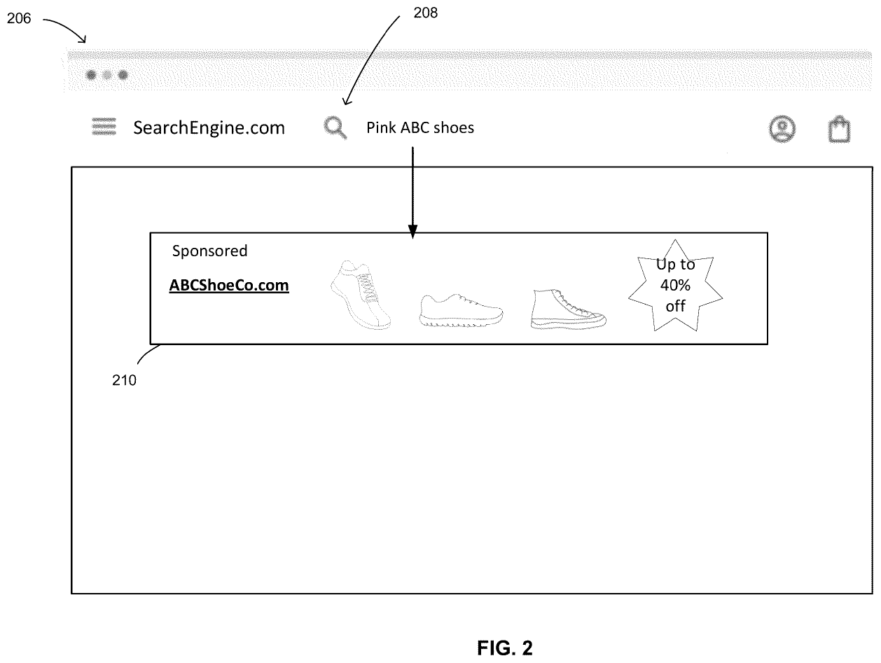

FIG. 2 is a partial screenshot illustrating a search query received by a publisher. For example, the publisher's website 206, or mobile application, may receive a search query in a search field 208. As shown, the search query may be for “pink ABC shoes.” The publisher may transmit a request to the digital content server for sponsored digital content items to be presented to the user in addition to the search results. The request may be based on the search query for “pink ABC shoes.” For example, the request may include a request for sponsored digital content items corresponding to or associated with pink ABC shoes.

The digital content server receives the request, including the terms of the search query, e.g., “pink ABC shoes,” and identifies candidate campaigns. For example, the digital content server may use language processing for the query “pink ABC shoes” to provide any spell correction, identify synonyms for each term and/or the entire query, identify terms associated with the terms in the search query, etc. The digital content server may use the query terms and/or the processing results to match the query with one or more campaigns. Candidate campaigns may specify included brands that match the query. Non-candidate campaigns may specify excluded brands for which digital content items should not be served if the search query matches the excluded brand.

In the example of FIG. 2, the search for “pink ABC shoes” matches the campaign 100B of FIG. 1, for which ABC Shoe Co. is specified as an included brand. Accordingly, the digital content item 210 corresponding to the campaign 100B (of FIG. 1) may be published on the publisher's website 206 in response to the search query.

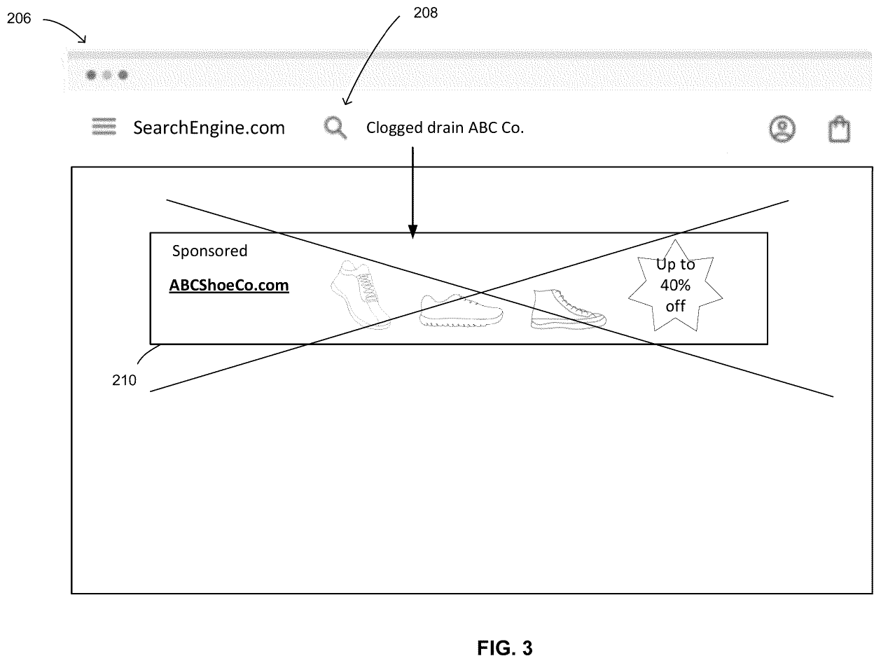

In the example of FIG. 3, the search term “ABC” may match multiple different brands, businesses, products, services, digital content providers, etc. In this example, the search query “clogged drain ABC co” may be entered. The digital content server may determine an intent of the search query based on the keywords or other information, such as prior searches or the like. Based on the intent, the digital content server may determine that the user who entered the query is searching for a plumbing company. Accordingly, while the search term “ABC” would match both ABC Shoe Co. and ABC Plumbers, the campaign 100B (FIG. 1) would be excluded because ABC Plumbers is explicitly listed as a brand for exclusion. Accordingly, the athletic shoe digital content item 210 will not be published in response to the search query for “clogged drain ABC.”

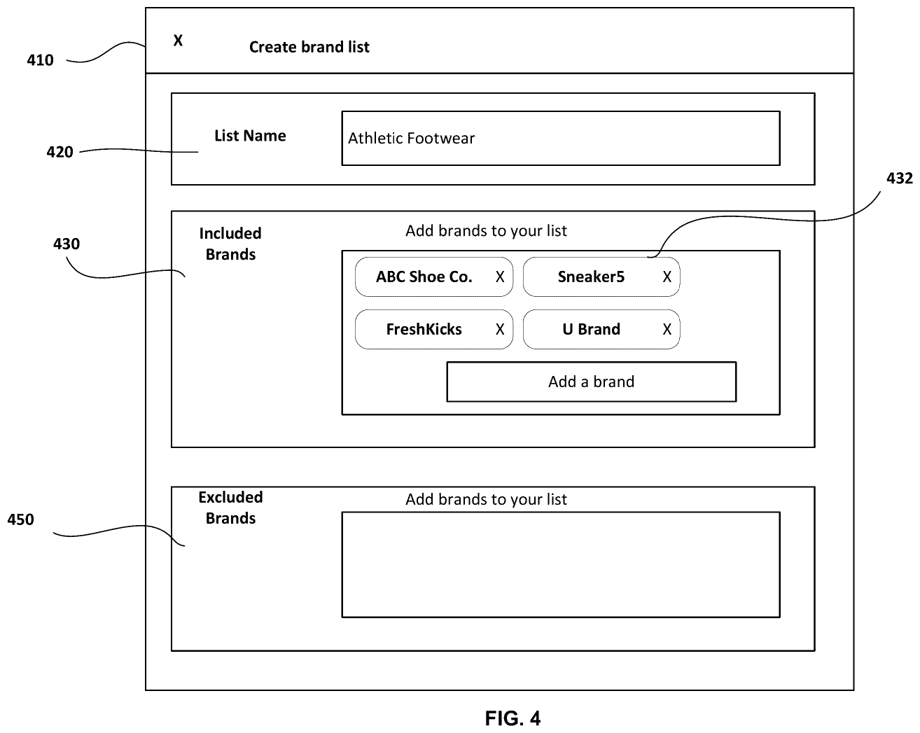

FIGS. 4-6 illustrate example user interfaces for creating campaigns. In particular, the examples illustrate an interface 410 for creation of a brand list for the campaigns. The interface 410 includes a name field 420 for naming the brand list. For example, a digital content provider may create multiple brand lists for one campaign or for various campaigns. For example, the digital content provider may create brand lists for different industries, product types, publishers, etc. As one example, the digital content provider may create a first brand list for footwear and a second brand list for clothing. In other examples, the digital content provider may create brand lists that are more granular in their distinctions, such as a first brand list for athletic footwear and a second brand list for sandals.

Included brands field 430 allows the digital content provider to specify which brands should be included in the campaign, such that if search queries match those brands the digital content items associated with the campaign may be selected for publication. As shown, multiple brands 432 may be selected for inclusion. The brands may be selected from an associated database that is linked with the interface 410. For example, the database may include a brand library listing all known brands and associated information, such as business information, URL, products, industry, other associated brands, etc.

Excluded brands field 450 allows the digital content provider to specify which brands should be excluded, such that the digital content items associated with the campaign will not be published when the query matches one of the excluded brands.

The digital content server may receive the campaigns from the digital content provider. The digital content server may receive a request from a publisher for one or more sponsored digital content items to be displayed alongside the search results of a search query received by the publisher's website. The brand list may be used to identify relevant digital content items in response to the search query.

The user interface may include one or more other input fields that are not shown, the other input fields configured to receive other details relating to the campaign. Such other details may include, for example, the campaign name, products, bid strategy, keywords, targeting, campaign duration, publisher information, budgets, etc.

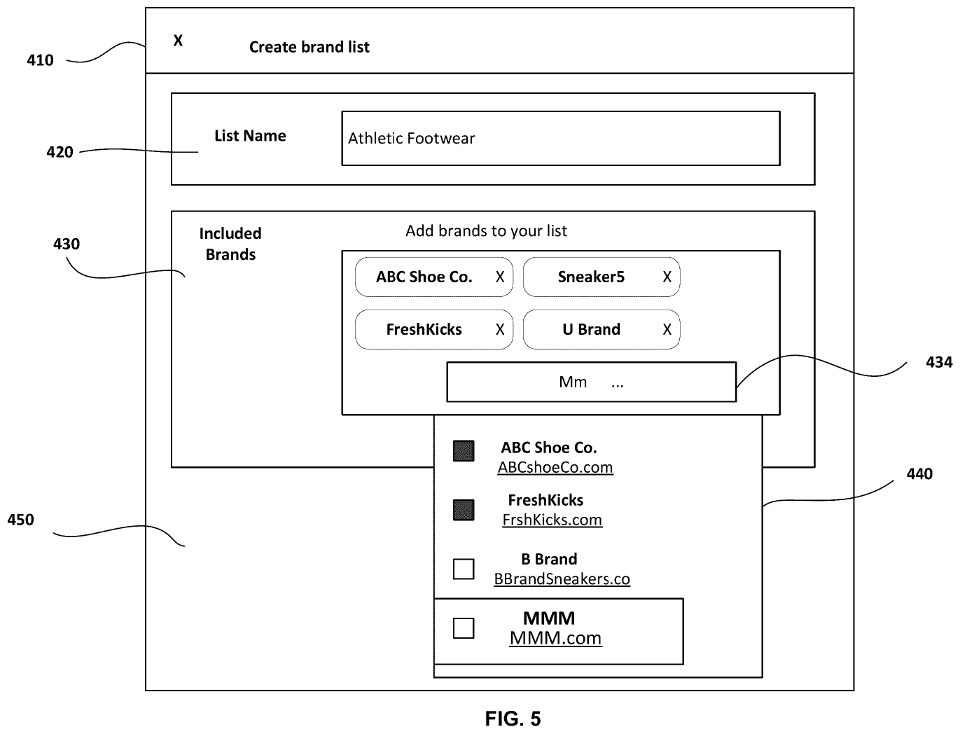

FIG. 5 illustrates an example of populating the included brands field 430. In this example, a drop-down list 440 is displayed, wherein the drop-down list 440 includes a listing of brands from the brand library. The listing provided in the drop-down list 440 may be filtered based on industry, product type, category, etc. In some examples, the user may add a brand by selecting one from the drop-down list 440. In this example, the list includes additional information for each brand, such as URL, which allows the user to determine that the correct brand is being selected. In some examples, additional information may be included, such as images, locations, alternate business names, etc. While a list is illustrated in this example, it should be understood that other types of data structures may be displayed for selection of a brand by the user.

In the example shown, the included brands field 430 further includes a text entry field 434. In this field 434, the user may type in particular brand name. For example, as the user begins typing, the digital content server may match the typed text to a brand name from the list 440 to suggest a brand to be added. For example, as shown, as the user begins to type “MM” the brand “MMM” may be suggested to the user for inclusion.

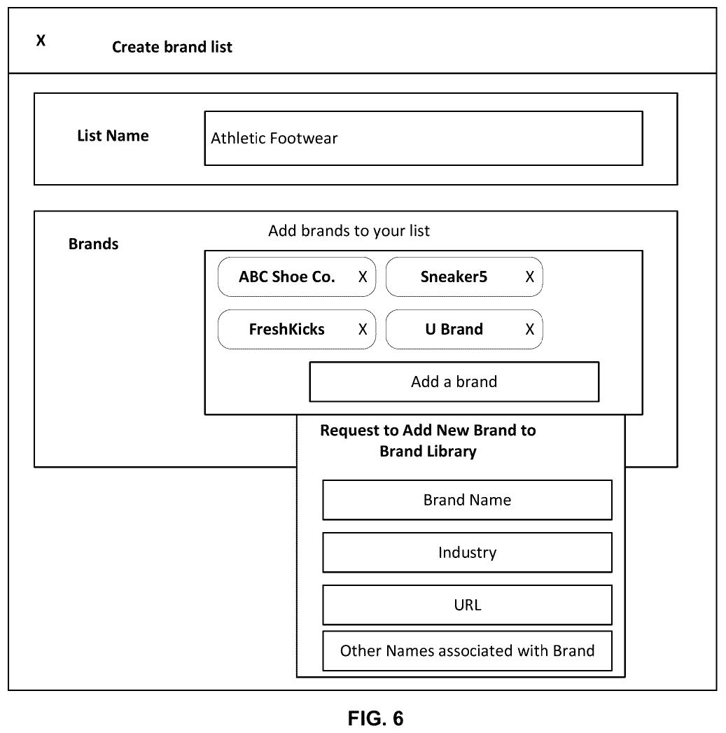

In some instances, a brand that the user desires to add to the exclusion or inclusion list may not be in the associated database or brand library. In such instances, the user may request that the brand be added. FIG. 6 illustrates an example user interface allowing for addition of brands that are not included in the brand library. As shown, a request to add a new brand may be entered through a request field, which seeks the brand name and other information such as industry, URL, other names associated with the brand, etc. The information may be reviewed for approval prior to adding the new brand to the brand library.

According to some examples, a verification process may be performed in response to receipt of an added brand from a digital content provider. The verification process may be manual or automatic. An automatic verification process may implement a large language model or other machine learning model to verify the added brand. By way of example, the model could search public records to determine whether the added brand has a pending or registered trademark, whether it has an associated logo, whether it has a web domain, or any other information that would suggest the added brand is valid. In further examples, the model could determine whether the added brand is related to other brands, such as if it is a sub-brand of another brand, if it is a variant of an existing brand, etc. Moreover, the model may compare the added brand to existing brands already listed in the brand library. In this regard, the model may determine if the added brand is a misspelling of an existing brand in the brand library, a variant, a related brand, etc. The information ascertained by the model may be scored and in some examples the scores may be weighted. For example, the added brand may receive a first number of verification points if it is a registered trademark, and a second different number of verification points if it has an associated web domain. In this regard, the added brand may receive a score, and if the score exceeds a predetermined validity threshold, then it will be considered valid. In response, the added brand can be added to the brand library, such that future campaigns can select the added brand for inclusion or exclusion.

While FIGS. 4-6 illustrate addition of individual brands to an inclusion list or an exclusion list in a campaign, it should be understood that the interface and logistics for adding brands can be modified. For example, a digital content provider can create a separate brand list that is stored, wherein the brand list can be selected for one or more campaigns. For example, a brand list can be specific to a particular category, industry, etc. By way of example, a digital content provider can create a brand list for “athletic footwear” and select one or more brands to add to the list. The digital content provider may also create a second brand list, such as for “dress shoes,” and select one or more brands for the second list. The lists may include the brands without specifying how the brands will be applied. When creating campaigns, the digital content provider may select the entire first list or second list for inclusion or exclusion.

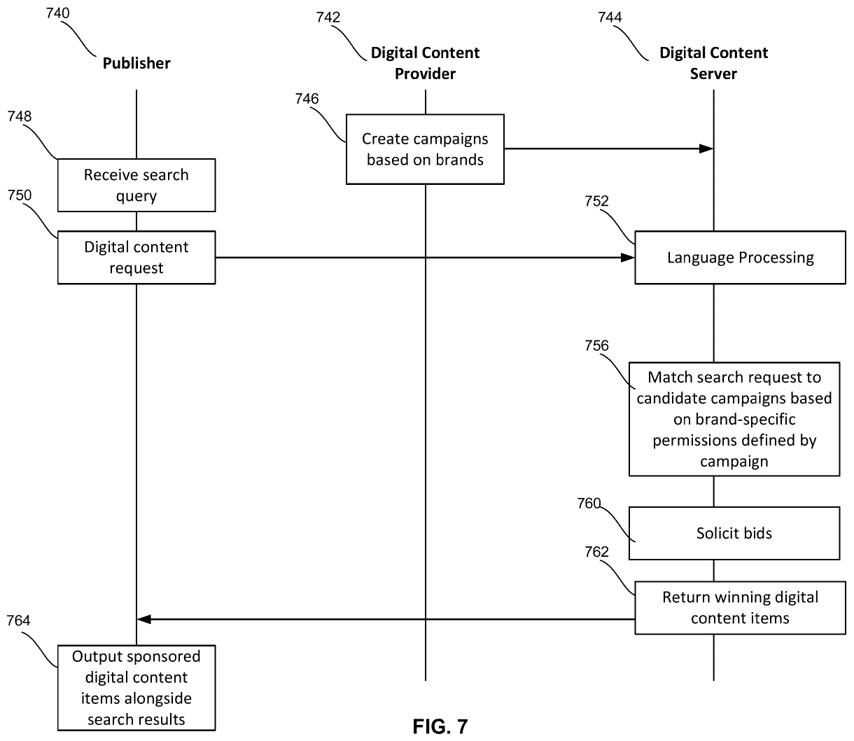

FIG. 7 is an example sequence diagram of steps that may occur among a publisher, a digital content provider, and a digital content server. The following operations do not have to be performed in the precise order described below. Rather, various operations can be handled in a different order or simultaneously, and operations may be added or omitted.

In block 746, the digital content provider 742 may create one or more campaigns. For example, the digital content provider 742 may identify products, web pages, search strings, or other information from the publisher 740 for which digital content items should be published. The campaigns allow the digital content provider to select one or more brands to be included or excluded, such that traffic may be directed based on the specified brands. In this regard, the specified brands may define permissions for brands for which the digital content items can be published or not. The digital content provider 742 may submit the campaigns to the digital content server 744. The digital content server 744 may store the campaigns.

In block 748, the publisher 740 may receive a search query through the publisher's website or mobile application. The search query may be a user submitted search query for a particular product or type of product.

In block 750, in response to receiving the search request, the publisher 740 may transmit a request to the digital content server 744 for sponsored digital content items to be displayed in association the search results for the search query.

In block 752, the digital content server 744 may use language processing to correct any spelling errors in the search terms, as necessary, and identify synonyms, or keywords, associated with the search terms.

In block 756 the digital content server 744 may match the search query to candidate campaigns based on the specified brands in the campaign.

In some examples, the digital content server 744 may solicit bids (block 760) from campaigns that specify the relevant brands as brand inclusions. In some examples, the digital content servers 744 may solicit bids from the digital content providers 742 of the identified relevant campaigns. The digital content providers 742 may bid to have their campaign displayed on the publisher's website in response to the search request. According to some examples, the bidding may occur automatically based on the bid strategy the digital content providers 742 included in the campaigns.

If bids are solicited, in block 762, after the conclusion of the bidding, the digital content server 744 may return the winning campaigns to the publisher 740.

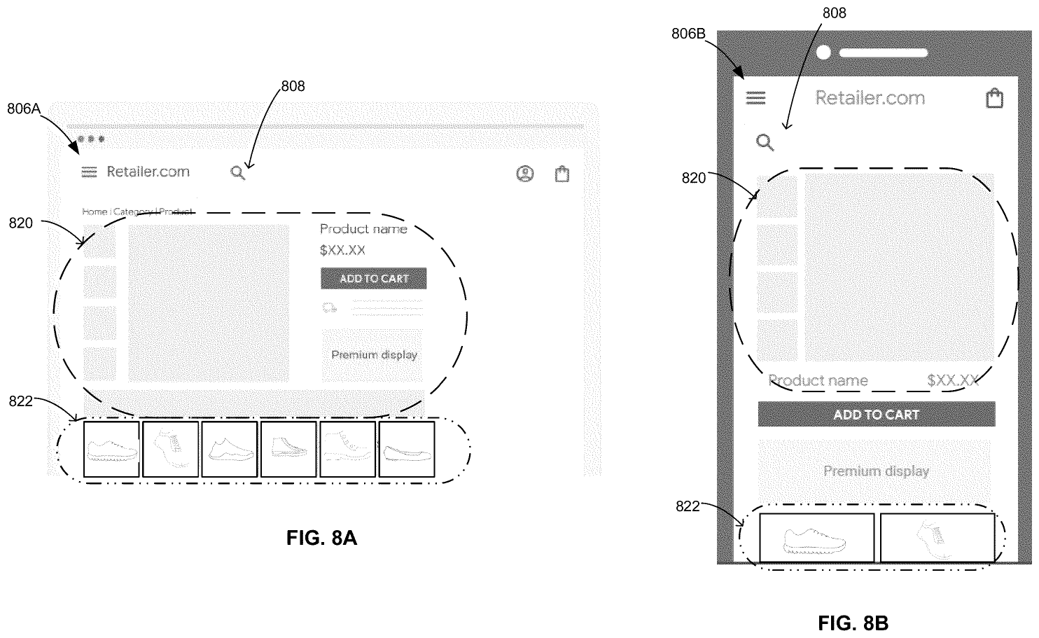

In block 764, the publisher may output the sponsored digital content items alongside the search results. An example output is shown in FIGS. 8A and 8B.

FIGS. 8A and 8B are screenshots of a publisher's website and publisher's mobile application, respectively, illustrating an example arrangement of content. The content may be provided in response to a user search query or content filter. The content may include, for example, details for one or more products 820, identification of related products, sponsored digital content items 822, etc. The publisher may be, for example, a retailer offering products for consumption by users.

The publisher's website 806A and/or the publisher's mobile application 806B may include a search field 808. A user may enter a search query into search field 808 to search a publisher's catalog of offered products. The search query may include search terms, such as a product name or type. Continuing with the example discussed in FIG. 2, the search query may be for “pink ABC shoes.”

In response to receiving the search query, the publisher may transmit a request to the digital content server for sponsored digital content items. The request may include the search terms of the search query. The digital content server may identify candidate campaigns permitting traffic for brands matching the search terms of the search query. For example, the digital content server may identify one or more candidate campaigns permitting traffic for brand ABC Shoe Co. The digital content server may also identify non-candidate campaigns which explicitly exclude the brand matching the search query. In some examples, the digital content server may solicit bids from digital content providers candidate campaigns. The digital content server may select a candidate campaign, such as from the digital content provider with the winning bid, and the selected campaign may be transmitted to the retailer to be published as sponsored digital content items 822 alongside the search results, e.g., product 820. Conversely, the digital content server may omit the non-candidate campaigns, such that unwanted traffic is not directed to such sites. For example, if ABC Plumbing is listed as an explicitly excluded brand, digital content items for ABC plumbing will not be published in response to the search query despite that the keywords “ABC” were a match.

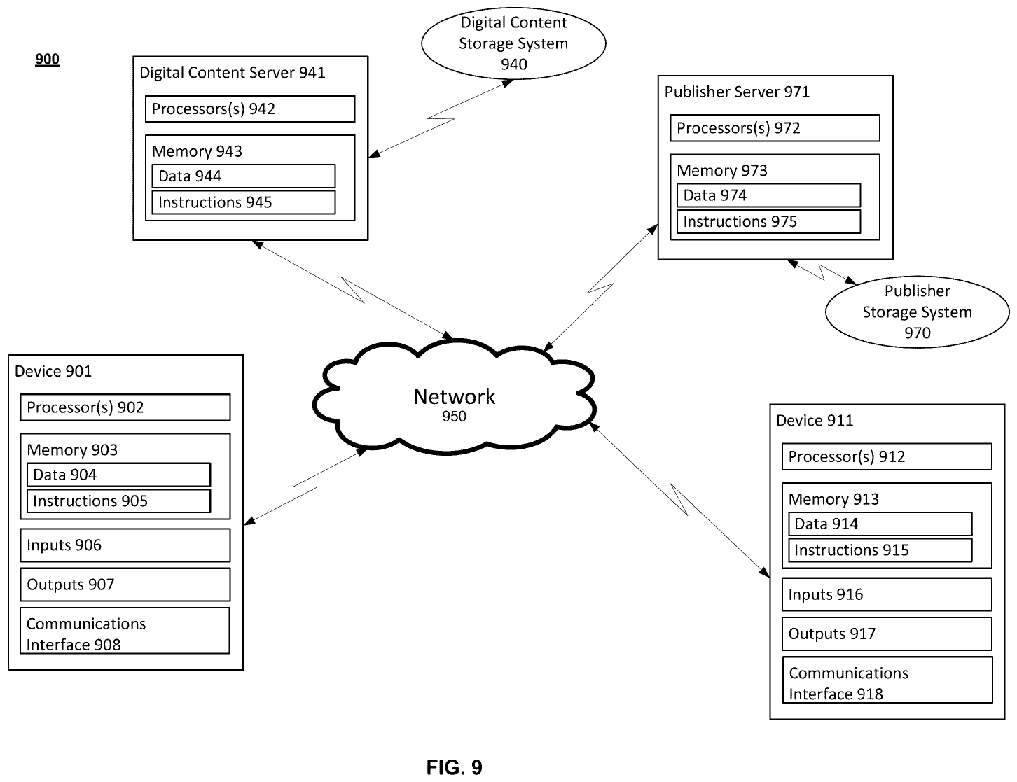

FIG. 9 illustrates an example system in which the features described above and herein may be implemented. It should not be considered as limiting the scope of the disclosure or usefulness of the features described herein. In this example, system 900 includes devices 901, 911, digital content servers 941, digital content server storage system 940, publisher server 971, publisher storage system 970, and network 950. For purposes of clarity, devices 901, 911 will be described with respect to device 901. However, it should be understood that device 911 may include the same or similar components and mat function in substantially the same way.

Device 901 may include one or more processors 902, memory 903, data 904 and instructions 905. Device 901 may also include inputs 906, outputs 907, and a communications interface 908. The devices 901 may be, for example, a smart phone, tablet, laptop, smart watch, AR/VR headset, smart helmet, home assistant, etc.

Memory 903 of device 901 may store information that is accessible by processor 902. Memory 903 may also include data that can be retrieved, manipulated, or stored by the processor 902. The memory 903 may be of any non-transitory type capable of storing information accessible by the processor 902, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 903 may store information that is accessible by the processors 902, including instructions 905 that may be executed by processors 902, and data 904.

Data 904 may be retrieved, stored, or modified by processors 902 in accordance with instructions 905. For instance, although the present disclosure is not limited by a particular data structure, the data 904 may be stored in computer registers, in a relational database as a table having a plurality of different fields and records, XML documents, or flat files. The data 904 may also be formatted in a computer-readable format such as, but not limited to, binary values, ASCII, or Unicode. By further way of example only, the data 504 may comprise information sufficient to identify the relevant information, such as numbers, descriptive text, proprietary codes, pointers, references to data stored in other memories (including other network locations) or information that is used by a function to calculate the relevant data.

The instructions 905 can be any set of instructions to be executed directly, such as machine code, or indirectly, such as scripts, by the processor 902. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods, and routines of the instructions are explained in more detail below.

The one or more processors 902 may include any processors, such as a commercially available CPU or microprocessor. Alternatively, the processor can be a dedicated component such as an ASIC or other hardware-based processor. Although not necessary, device 501 may include specialized hardware components to perform specific computing functions faster or more efficiently.

Although FIG. 9 functionally illustrates the processor, memory, and other elements of device 901 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of device 901. Accordingly, references to a processor or device will be understood to include references to a collection of processors or devices or memories that may or may not operate in parallel.

The inputs 906 may be, for example, a mouse, keyboard, touch-screen, microphone, or any other type of input. The inputs may receive key words for a search on a publisher's website or mobile application.

Output 907 may be a display, such as a monitor having a screen, a touch-screen, a projector, or a television. The display 907 of the device 901 may electronically display information to a user via a graphical user interface (“GUI”) or other types of user interfaces. For example, display 907 may electronically display product information and sponsored digital content items on a publisher's website or mobile application.

The devices 901 can be at various nodes of a network 950 and capable of directly and indirectly communicating with other nodes of network 550. Although two devices are depicted in FIG. 9, it should be appreciated that a typical system can include one or more computing devices, with each computing device being at a different node of network 950. The network 950 and intervening nodes described herein can be interconnected using various protocols and systems, such that the network can be part of the Internet, World Wide Web, specific intranets, wide area networks, or local networks. The network 950 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

System 900 may include one or more server computing devices, such as digital content server 541 and publisher server 971. The server computing devices may be, for example, a load balanced server farm, that exchange information with different nodes of a network for the purpose of receiving, processing, and transmitting the data to and from other computing devices. For instance, digital content server 941 and publisher server 971 may be a web server that is capable of communicating with the device 901 via the network 950. In addition, digital content server 941 and publisher server 971 may use network 950 to transmit and present information to a user of device 901. Digital content server 941 and publisher server 971 may include one or more processors 942, 972, memory 943, 973, data 944, 974, instructions 945, 975, etc. These components operate in the same or similar fashion as those described above with respect to device 901.

Digital content server 941 may manage content, such as sponsored digital content items, and provide various services to the digital content providers, publishers, and devices 901. According to some examples, digital content server 941 may receive campaigns from one or more digital content providers. The campaigns may include campaign information, such as the products to be sponsored, bidding strategy, targeting information, duration, etc. The campaigns may be stored in the memory 943 of digital content server 941 and/or in digital content server storage system 940.

According to some examples, publisher server 971 may receive a search query from device 901. For example, the search query may be for specific content, such as product information. In response the request, publisher server 971 may retrieve relevant content from publisher storage system 970. The publisher server 971 may transmit a content page or other presentation, representation, or characterization of the content to the requesting device 901. The content page may include, for example, sponsored digital content items.

According to some examples, in response to the received search query, publisher server 971 may transmit a request to digital content server 941. Digital content server 941 may facilitate the identification of relevant digital content items for distribution to the publishers, such as by selecting candidate campaigns based on brand-specified permissions. For example, digital content server 941 may identify businesses matching the search query that were explicitly included in the campaign and serve digital content items from the campaign in response to the search query. As another example, the digital content server 941 may identify businesses matching the search query that were explicitly excluded from the campaign, and prevent the digital content items from the campaign from being served with the response to the search query. If the search query matches two brands, where one is on the inclusion list and the other is on the exclusion list, a default operation may be to exclude the campaign.

Device 901 may present in a viewer, such as a browser, mobile application, or other content display system, the search query results integrated with one or more of the sponsored digital content items provided by the digital content server 941.

In addition to the foregoing systems, methods according to the present disclosure are described. While these methods include a plurality of operations that are described in a particular order below, the operations do not have to be performed in the precise order described. Rather, various operations can be handled in a different order or simultaneously. Moreover, operations may be added or omitted.

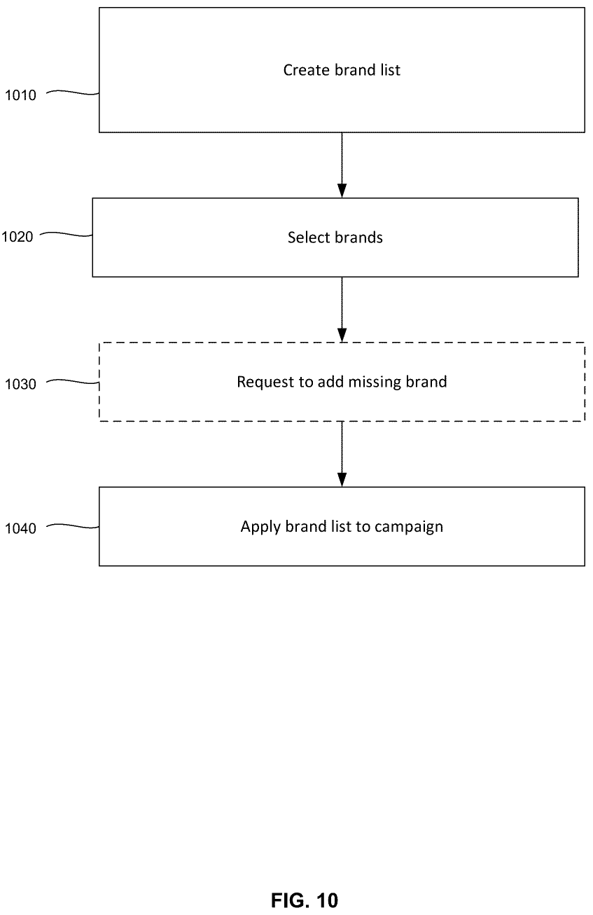

FIG. 10 illustrates an example method for creating a campaign including a brand list. The brand list may be a brand inclusion list, a brand exclusion list, or both.

In block 1010, the brand list is created. For example, a user interface may provide an output display prompting a user to start a new brand list, or to edit an existing brand list. When creating the brand list, the user interface may provide an output including one or more fields, such as those discussed above in connection with FIG. 4.

In block 1020, brands are selected. For example, a brand library may include all known brands and associated information, such as web domains, industries, products, related brands, trademark registrations, logos, etc. In some examples, the brand library may be automatically generated using artificial intelligence or machine learning techniques. For example, brands may be discovered by Internet searches and added to the brand library. When selecting a brand, the user may type a name of the brand, select the brand from a list, or otherwise select the brand. In some examples, as the user begins typing the brand name into a field, suggested matches may be presented to the user, prompting the user to select one. In this regard, if the user misspells the brand, they can be redirected to the correct brand. Similarly, if the name of the brand has multiple associated businesses, the user can identify the correct business for inclusion in the list. For example, multiple brand listings may be suggested as a match, and may be suggested with additional information that allows the user to distinguish which brand corresponds to the brand they intended. For example, if the name of a brand relates to both a jewelry company and a music streaming service, when the user enters the name two entries from the brand library may be suggested. The entries may be displayed along with information such as industry, products, services, logos, websites, or other information that allows the user to distinguish the brands and the select the brand they intended.

In some examples, a user may request to add a brand that is missing from the brand library. For example, new brands are established daily as businesses are formed, new products come to markets, products and services are re-branded, etc. A user may desire to add a new brand to the brand list, though the brand may not yet be listed in the brand library. Accordingly, the user may submit a request to add the new/missing brand. The request may be verified at the digital content server. Such verification may be manually performed by an operator, or may be automatically performed, such as by a trained machine learning model. Once verified, the new brand may be added to the brand library such that it may be selected for inclusion in the brand list.

In block 1040, the brand list may be applied to a campaign. For example, the campaign may include information for a digital content item to be served on a publisher's site in response to a search query. The information may include a business information, such as a name or contact information, content, such as images or text describing goods or services offered by the business, and other information, such as links to the digital content provider's website. The campaign may include additional information, such as keywords that would match the campaign if entered in the search query. By applying the brand list to the campaign, the campaign may also include a list of specific brands to be included or excluded. For example, when a query matches a brand added as an included brand on the brand list, the campaign be selected to serve a digital content item in response to the query. In contrast, when the query matches a brand added as an excluded brand, the campaign will be restricted or filtered out from candidate campaigns responsive to the query.

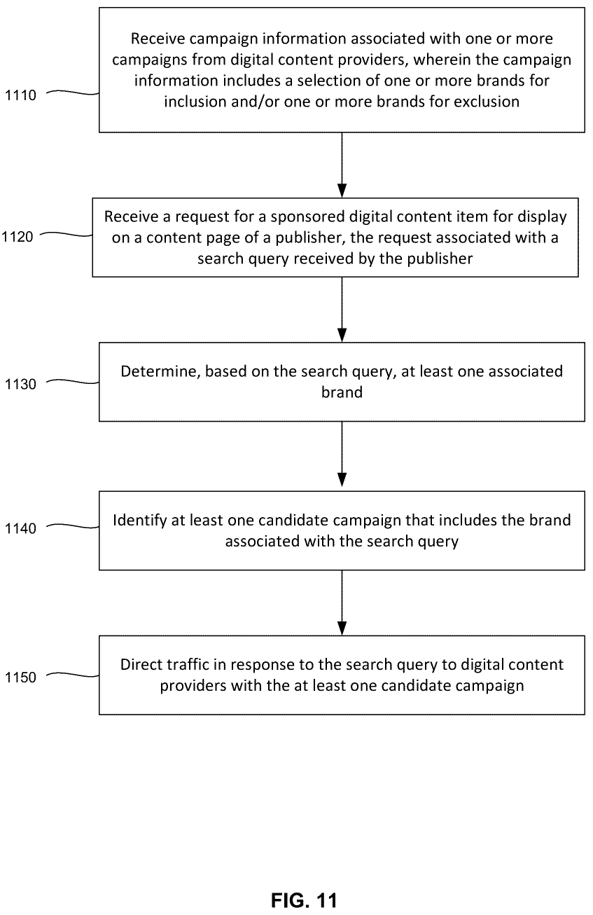

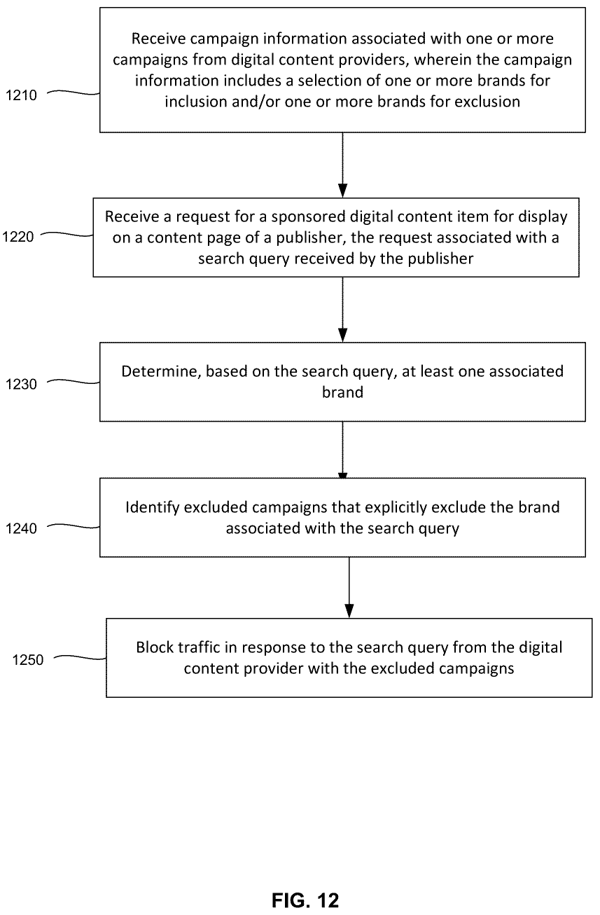

FIGS. 11-12 describe methods of directing ad traffic based on brands explicitly identified in campaigns. FIG. 11 describes a method of directing traffic based on brands specified for inclusion. FIG. 12 describes a method of directing traffic based on brands specified for exclusion.

With respect to FIG. 11, in block 1110 a campaign is received. The campaign may include information from digital content providers for a digital content item to be published. Such information may include, for example, content and parameters within which the content should be served. Such parameters may include, for example, keywords or related products or other signals that match the content, such that the content should be served in response to such signals at the publisher's site.

In block 1120, the system may receive a request for a sponsored digital content item for display on a content page of a publisher. The request may be associated with a search query or content filter received by the publisher. According to some examples, receiving the request for the sponsored digital content item may further include receiving at least one search term or category associated with the search query or content filter on the content page of the publisher.

In block 1130, the system may determine, based on the search query, at least one associated brand that is associated with the search query. For example, if the search query include “pink ABC shoes” the system may determine that ABC Shoe Co. is the associated brand. The determination may be based on matching keywords, such as brand name ABC, as well as other context. The other context may include other terms in the query, such as “pink” and “shoes.” In other examples, the other context may include browsing history, user profile information such as user preferences, etc.

In block 1140, the digital content server may identify at least one candidate advertising campaign that includes the brand associated with the search query. For example, the digital content server may identify campaigns that include brand lists where the associated brand is explicitly included. In some examples multiple campaigns may be identified. Moreover, campaigns may be identified based on other matching parameters, such as keywords or other signals. The digital content server may use any of a variety of techniques to select one or more of the identified candidate advertising campaigns. Examples of such techniques may include weighting the campaign parameters, scoring, ranking, bidding, etc. For example, the system may receive bids from the digital content providers of the identified at least one or more advertising campaigns.

In block 1150, the system may direct traffic in response to the search query to digital content providers with the at least one candidate campaign. For example, a selected candidate campaign may be used to serve content on the publisher's site. Such content may include a link to the digital content provider's site. The content may be positioned among other content on the publisher's site such as to encourage a user to interact with the content. For example, a link to the digital content provider's site may be positioned at top of a list of search results as a sponsored result. In this regard, traffic is directed to campaigns based on the matched brands.

In FIG. 12, blocks 1210-1230 correspond to blocks 1110-1130 of FIG. 11. In this example, the brand list includes explicit brand exclusions. Accordingly, in block 1240, the digital content server identifies campaigns with brand lists in which brands are explicitly excluded. For example, for the search query “clogged drain ABC Co.” the brand “ABC” may match with both “ABC Shoe Co.” and “ABC Plumbers.” In this example, based on the context, the search query appears to be intended for ABC Plumbers. In its campaign, the digital content provider for ABC Shoe Co. may explicitly exclude the brand ABC Plumbers. As such, in block 1250, the content will not be published when the search query matches with ABC Plumbers. Rather, the campaign will be excluded from consideration in the candidate campaigns. By excluding the campaigns in which an explicitly excluded brand matches the search query, computing and network resources are conserved. For example, excluding such campaigns reduces a total number of campaigns to be considered for serving an ad, thereby reducing processing power. It further reduces the possibility of serving irrelevant digital content items, and therefore conserves the network bandwidth and display power that would be consumed by otherwise serving such irrelevant digital content items.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method, comprising:
receiving, by one or more processors, campaign information associated with one or more campaigns from digital content providers, wherein the campaign information includes a selection of one or more specified brands;
receiving, by the one or more processors from a publisher, a request for a sponsored digital content item for display on a content page of a publisher, the request associated with a search query received by the publisher;
determining, by the one or more processors based on the search query and the one or more specified brands, one or more candidate campaigns;
selecting, by the one or more processors, a selected campaign of the one or more candidate campaigns; and
providing to the publisher a digital content item associated with the selected campaign for publishing in association with a response to the search query.

2. The method of claim 1, wherein the selected one or more specified brands includes a specified brand inclusion list of included brands for which the campaign should be included as a candidate campaign if the one or more specified brands match the search query.

3. The method of claim 1, wherein the selection of one or more specified brands includes a specified brand exclusion list of excluded brands for which the campaign should not be included as a candidate campaign if the one or more specified brands match the search query.

4. The method of claim 1, wherein the selection of the one or more specified brands comprises selection through a user interface of brands listed in a brand library.

5. The method of claim 4, wherein the brand library identifies one or more uniform resource locators (URLs) associated with each brand.

6. The method of claim 4, wherein the brand library identifies a business associated with each brand.

7. The method of claim 4, wherein the brand library identifies an industry, product, or service associated with each brand.

8. The method of claim 1, further comprising ranking, by the one or more processors based on the determined degree of the match, the one or more candidate campaigns.

9. The method of claim 1, further comprising:
receiving, by the one or more processors from the digital content providers of the identified at least one or more campaigns, bids on the highest ranked one or more available products; and
providing, by the one or more processors for output on the content page of the publisher based on a winning bid, the at least one campaign as a sponsored digital content item.

10. A system, comprising:
memory; and
one or more processors, the one or more processors configured to execute operations comprising:
receiving campaign information associated with one or more campaigns from digital content providers, wherein the campaign information includes a selection of one or more specified brands;
receiving, from a publisher, a request for a sponsored digital content item for display on a content page of a publisher, the request associated with a search query received by the publisher;
determining, based on the search query and the one or more specified brands, one or more candidate campaigns;
selecting a selected campaign of the one or more candidate campaigns; and
providing to the publisher a digital content item associated with the selected campaign for publishing in association with a response to the search query.

11. The system of claim 10, wherein the selected one or more specified brands includes a specified brand inclusion list of included brands for which the campaign should be included as a candidate campaign if the one or more specified brands match the search query.

12. The system of claim 10, wherein the selection of one or more specified brands includes a specified brand exclusion list of excluded brands for which the campaign should not be included as a candidate campaign if the one or more specified brands match the search query.

13. The system of claim 10, wherein the selection of the one or more specified brands comprises selection through a user interface of brands listed in a brand library.

14. The system of claim 13, wherein the brand library identifies one or more uniform resource locators (URLs) associated with each brand.

15. The system of claim 13, wherein the brand library identifies a business associated with each brand.

16. The system of claim 13, wherein the brand library identifies an industry, product, or service associated with each brand.

17. The system of claim 10, wherein the one or more processors are further configured to rank, based on the determined degree of the match, the one or more candidate campaigns.

18. The system of claim 10, further comprising:
receiving, by the one or more processors from the digital content providers of the identified at least one or more campaigns, bids on the highest ranked one or more available products; and
providing, by the one or more processors for output on the content page of the publisher based on a winning bid, the at least one campaign as a sponsored digital content item.

19. A non-transitory computer-readable medium storing instructions, which when executed by one or more processors, cause the one or more processors to execute a method comprising:
receiving campaign information associated with one or more campaigns from digital content providers, wherein the campaign information includes a selection of one or more specified brands;
receiving, from a publisher, a request for a sponsored digital content item for display on a content page of a publisher, the request associated with a search query received by the publisher;
determining, based on the search query and the one or more specified brands, one or more candidate campaigns;
selecting a selected campaign of the one or more candidate campaigns; and
providing to the publisher a digital content item associated with the selected campaign for publishing in association with a response to the search query.
